(19) United States
(12) Patent Application Publication
(10) Pub. No.: US 2010/0290931 A1
(43) Pub. Date: Nov. 18, 2010

(54) HAND-ACTUATED PUMP

(76) Inventors: Anthony Jonathan Sanders, Durham (GB); Tim Austen, Glencoe, IL (US); Brian Coleman, Hawthorn Woods, IL (US)

Correspondence Address: BRINKS HOFER GILSON & LIONE, P.O. BOX 10395, CHICAGO, IL, 60610, US

(21) Appl. No.: 12/844,376

(22) Filed: Jul. 27, 2010

Related U.S. Application Data
(63) Continuation-in-part of application No. 12/562,814, filed on Sep. 18, 2009.
(60) Provisional application No. 61/098,940, filed on Sep. 22, 2008.

(51) Int. Cl. F04B 9/14; B05B 11/00; F16K 15/20

(52) U.S. Cl. 417/374; 222/634; 137/231; 417/234

(57) ABSTRACT

A hand-actuated pump includes a cylinder with a proximal end and a distal end. The distal end defines an opening. The hand-actuated pump also includes a piston with a proximal end. The proximal end of the piston is configured to be slidably inserted into the distal end of the cylinder. An exhaust port is positioned at the proximal end of the cylinder and includes a coupler that is configured to be removably attached to an inflatable object and to communicate air to the inflatable object. The coupler is also configured to be selectively locked in an extended position and a closed position.

### RELATED APPLICATIONS

This application is a continuation-in-part of U.S. application Ser. No. 12/562,814, filed Sep. 18, 2009, which claims the benefit of the filing date of U.S. provisional Application Ser. No. 61/098,940, filed Sep. 22, 2008, both of which are hereby incorporated by reference it their entirety.

### BACKGROUND

I. Field

The present invention relates generally to pumps. More specifically, the present invention relates to a hand-actuated pump for filling an inflatable object.

II. Background Details

Inflatable mattresses have become popular due to their utility as an extra bed needed around the house or on camping trips. An advantage of such inflatable mattresses is that they are portable and easily stored. A pump is typically required to fill these mattresses quickly and efficiently. For example, a battery operated or corded pump may be provided with the mattress and adapted to fill the mattress with air.

However, power outlets are not typically available on camping trips, and batteries have to be replaced.

### SUMMARY

An embodiment of a hand-actuated pump includes a cylinder with a proximal end and a distal end. The distal end defines an opening. The hand-actuated pump also includes a piston with a proximal end. The proximal end of the piston is configured to be slidably inserted into the distal end of the cylinder. An exhaust port is positioned at the proximal end of the cylinder and includes a coupler that is configured to be removably attached to an inflatable object and to communicate air to the inflatable object. The coupler is also configured to be selectively locked in an extended position and a closed position.

### BRIEF DESCRIPTION

The accompanying drawings are included to provide a further understanding of the invention and are incorporated in and constitute a part of this specification. The detailed description and illustrated embodiments of the invention serve to explain the principles of the invention.

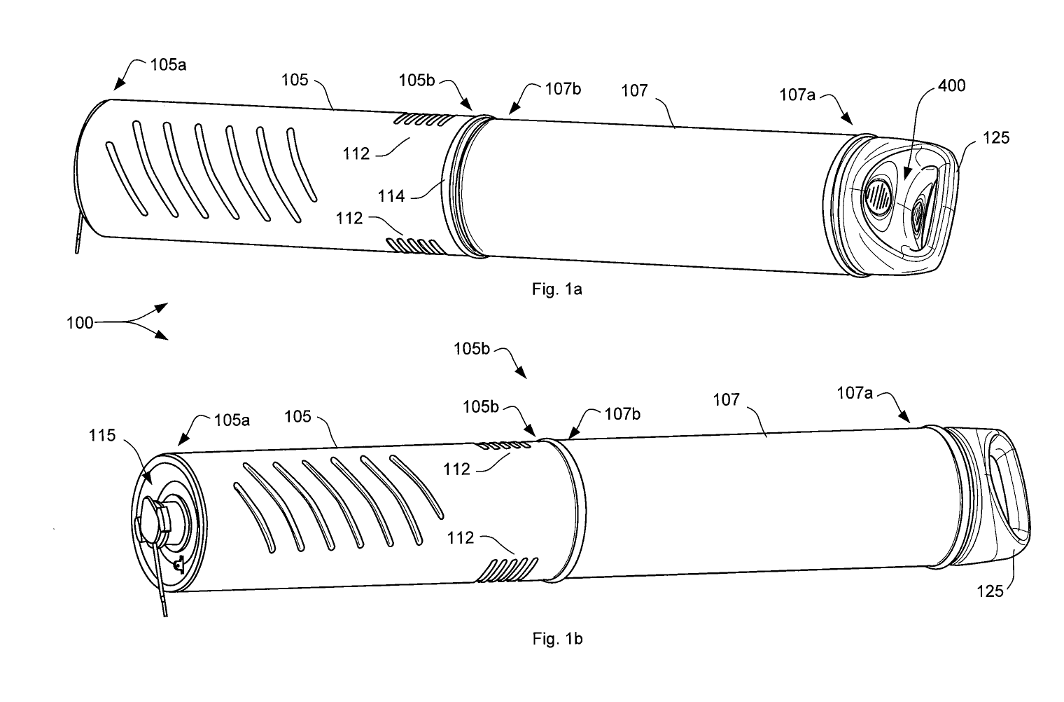

FIG. 1a and FIG. 1b are perspective views of one embodiment of a hand-actuated pump in an extended position;

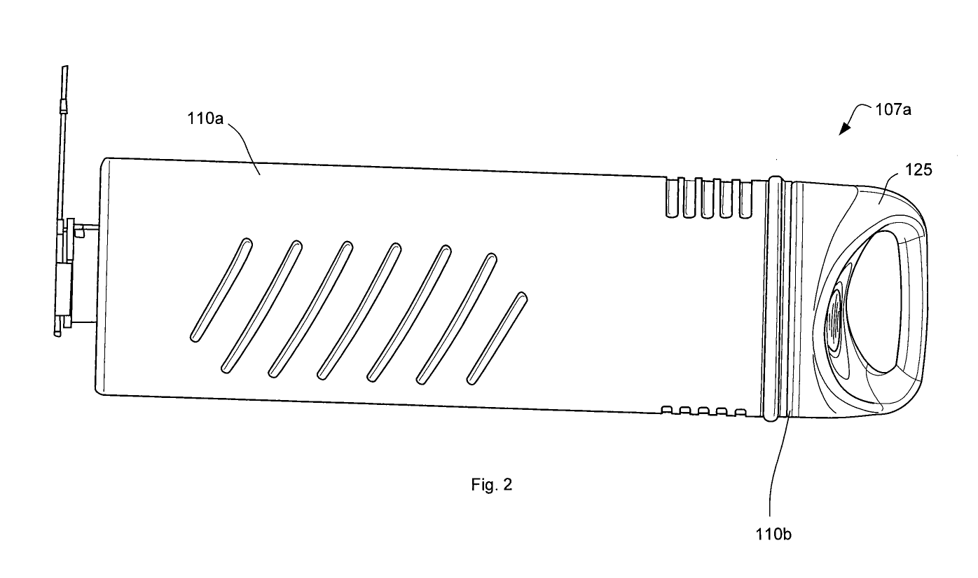

FIG. 2 is a perspective view of the hand-actuated pump embodiment of FIG. 1a in a closed position;

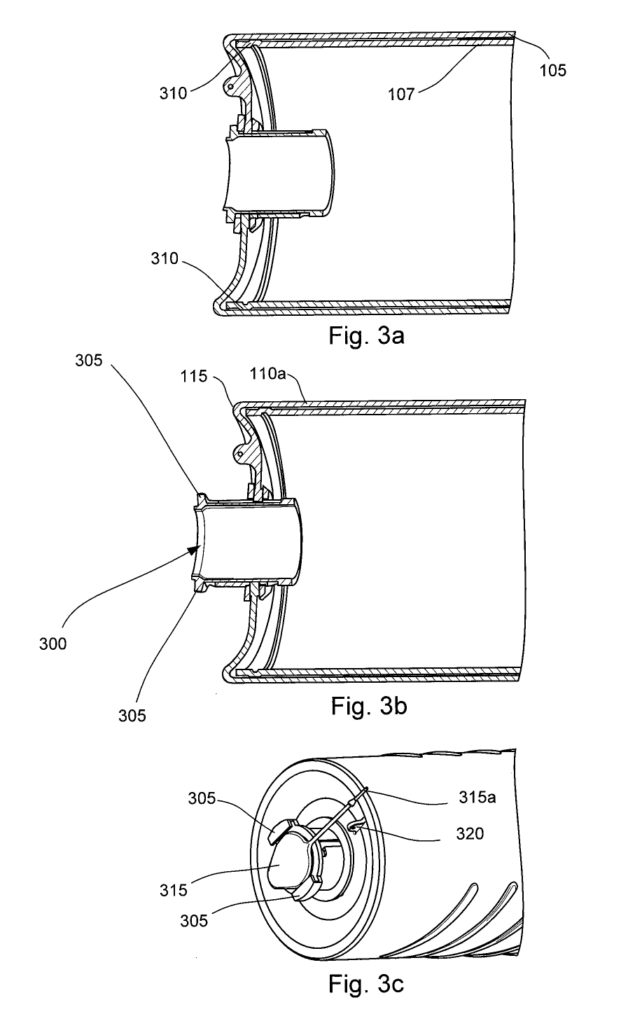

FIGS. 3a-3c are views of the exhaust port of the hand-actuated pump embodiment of FIG. 1a;

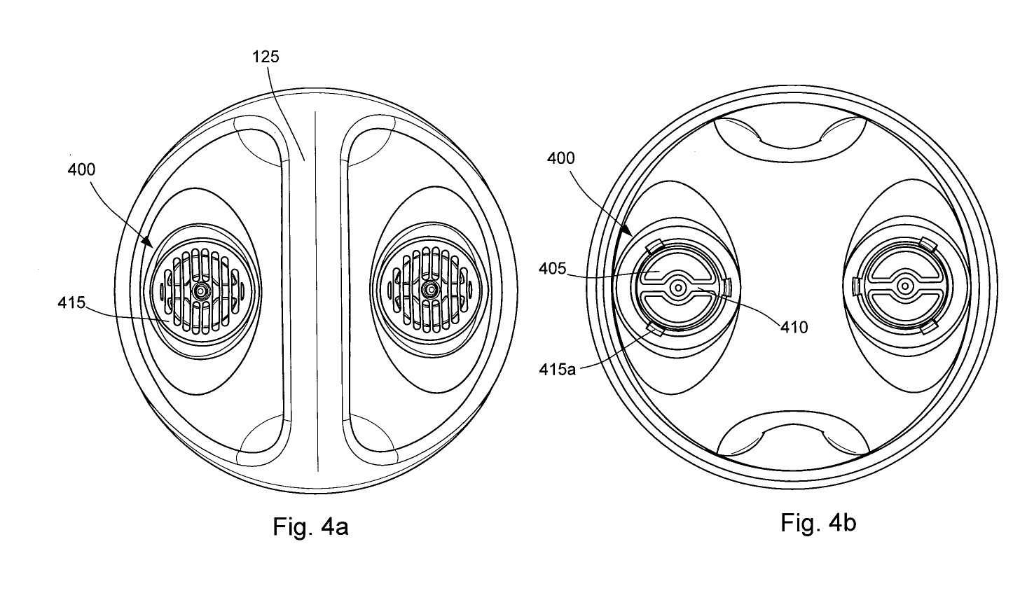

FIG. 4a is a view of the valve cover of the embodiment of FIG. 1a from the outside of the piston;

FIG. 4b is a view of the valve cover of the embodiment of FIG. 1a from the inside of the piston;

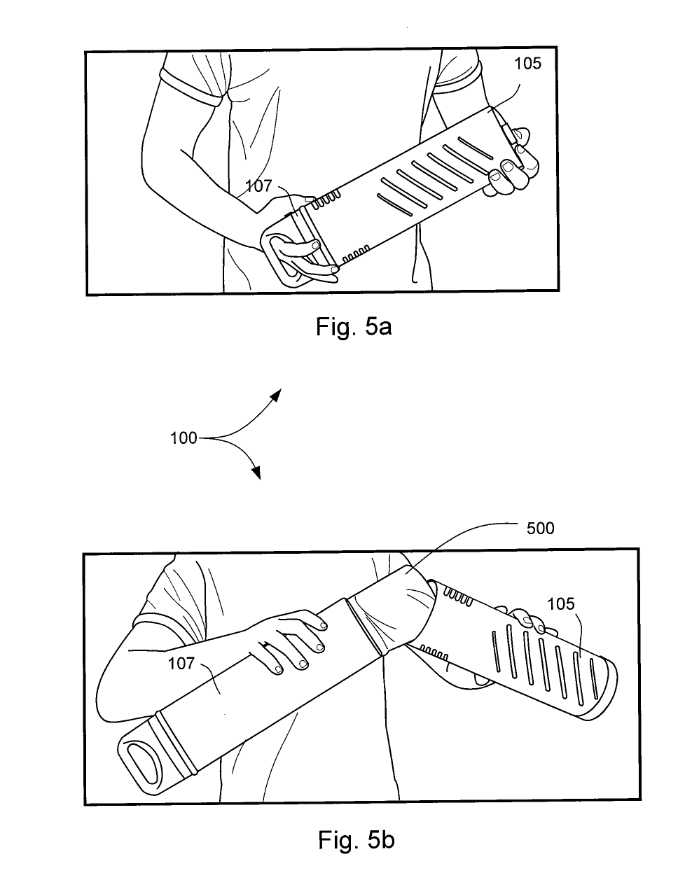

FIG. 5a and FIG. 5b illustrate an unpacking operation of the embodiment of the hand-actuated pump in FIG. 1a;

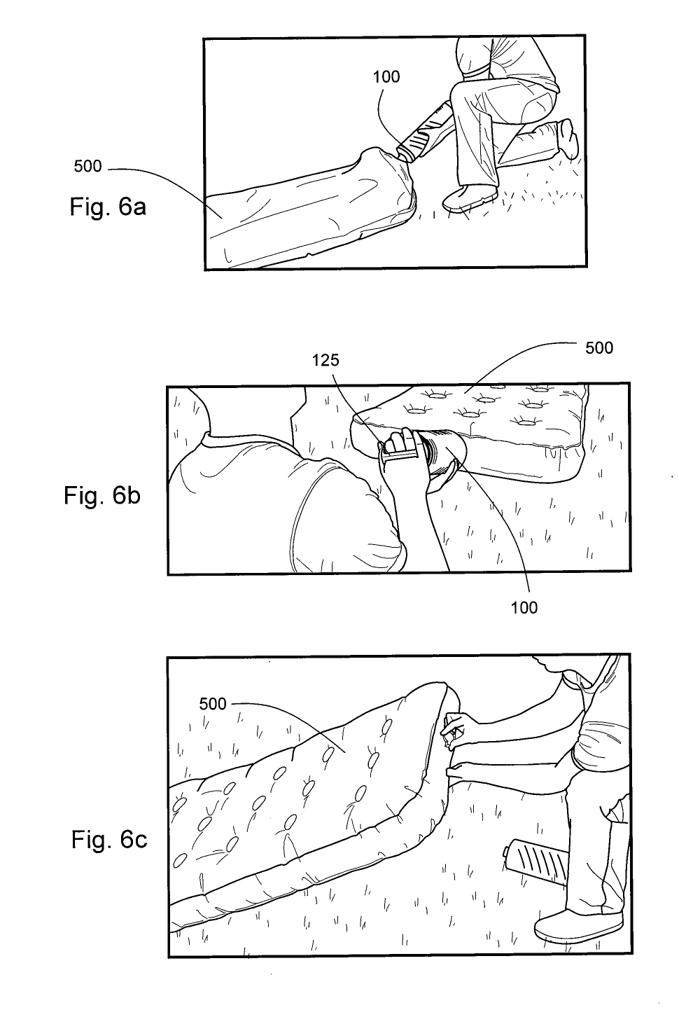

FIG. 6a- FIG. 6c illustrate a pumping operation of an embodiment of a hand-actuated pump as shown in FIG. 1a;

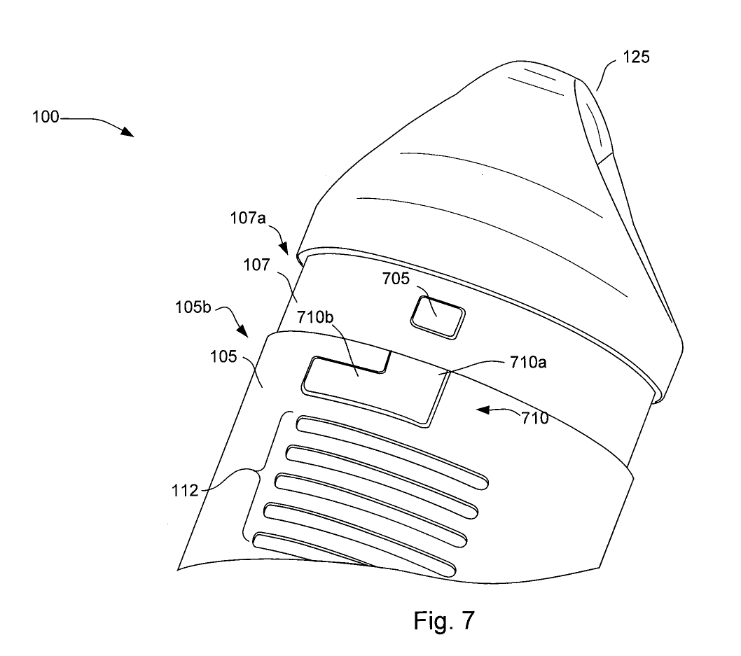

FIG. 7 illustrates locking members of the hand-actuated pump for locking the cylinder and piston together; and

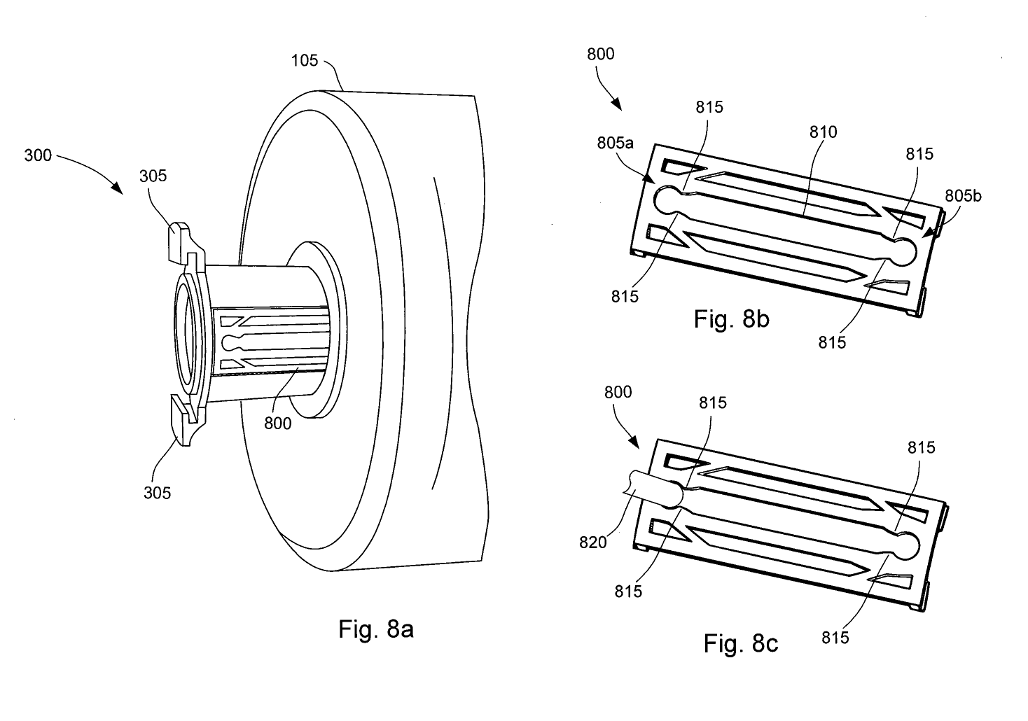

FIGS. 8a-8c illustrate locking members of the hand-actuated for locking a coupler of the hand-actuated pump in either an extended or a closed position.

### DETAILED DESCRIPTION OF THE INVENTION

FIG. 1a and FIG. 1b are perspective views of a hand-actuated pump 100 in an extended position. The hand-actuated pump 100 includes a cylinder 105 and a piston 107 configured to be fully inserted into the cylinder 105, as shown in FIG. 2 The repetitive insertion and removal of the piston 107 enables the inflation of an inflatable object, such as a flexible inflatable support. The cylinder 105 and piston 107 are generally cylindrical in shape and define an inner chamber. However, other geometries may be utilized. The cylinder 105 and piston 107 may comprise any material suitable to enable pumping operations, such as plastic, metal, or a different material.

The distal end 107a of the piston 107 defines a handle 125 that enables pulling the piston 107 out of the cylinder 105. A pair of valves 400 enabling air to be drawn into the pump 100 are positioned at the distal end 107a of the piston 107. Alternatively or in addition, the valves 400 may positioned elsewhere on the pump 100, such as at the proximal end 105a of the cylinder 105, or a different location of the cylinder 105. The number of valves 400 may be increased or decreased depending on the amount of air flow desired. The valves 400 are described in more detail below.

The inside diameter of the cylinder 105 and the outside diameter of the piston 107 are sized to allow the piston 107 to slide inside the cylinder 105 and to form a substantially air tight seal between the piston 107 and the cylinder 105. In some implementations, the piston 107 may define a raised annular ridge, hereinafter referred to as a ring 310, on the outside surface towards the proximal end of the piston, as shown in FIG. 3a. The ring 310 may further improve the seal between the piston 107 and cylinder 105.

Returning to FIG. 1, the cylinder 105 may define one or more raised annular ridges, hereinafter referred to as rumble strips 112, at the distal end 105b. The rumble strips 112 are configured to engage the ring 310 (FIG. 3) defined on the piston 107. The rumble strips 112 and ring 310 cooperate to produce noise when the ring 310 is drawn across the rumble strips 112. The noise in turn warns an operator that the piston 107 is near the end of its operative position. The number of rumble strips 112 may be increased or decreased to increase or decrease the intensity of the warning provided to the operator.

The cylinder 105 may define a raised annular ridge 114 at the distal end 105b with an interior surface (not shown) configured to engage the ring 310 and generally prevent the piston 107 from being completely removed from the cylinder 105 during pumping operations.

The proximal end 105a of the cylinder 105 defines an exhaust port 115. The exhaust port 115 enables attachment of the hand-actuated pump to an inflatable object such as an air mattress. The exhaust port 115 is utilized to communicate air to the inflatable object and may be integrally formed with the cylinder 105 or may be removably attached. For example, the exhaust port 115 may be glued, welded, or screwed to the cylinder 105.

FIGS. 3a and 3b are cross-sectional views of the exhaust port 115 (FIG. 1b). The exhaust port 115 includes a coupler 300 and a cover 315. In some implementations, the coupler is generally cylindrical and is configured to move within an opening defined in the proximal end 105a of the cylinder 105.

The coupler 300 may include locking members 305 that enable removable attachment of the hand-actuated pump 100 to an inflatable support. For example, the hand-actuated pump 100 may be locked to the inflatable object by sliding the coupler inside a complementary port (not shown) on the inflatable object. The coupler 300 may then be rotated so that the locking members 305 engage complementary locking members (not shown) on the inflatable object. The hand-actuated pump 100 may be removed by reversing the direction of rotation of the coupler 300. Locking the hand-actuated pump 100 to the inflatable object enables an operator to concentrate his efforts on filling the inflatable object with air rather than trying to forcibly keep the hand-actuated pump 100 and inflatable object together.

The cover 315 is configured to be inserted into an opening of the coupler and may prevent objects from entering the hand-actuated pump when not in use. The cover 315 includes a tail 315a configured to be inserted into the retention tab 320 located on the proximal end 105a of the cylinder 105. The retention tab 320 defines an opening for receiving the tail 315a of the cover 315.

FIG. 4a and FIG. 4b are front and back views, respectively, of the valves 400. The valves 400 enable unidirectional flow of air into the piston during pumping operations. When the piston and cylinder are pulled apart, the valves 400 allow air to enter the inner chamber defined by the piston 107 and cylinder 105. When the piston 107 and cylinder 105 are pushed together, the valves 400 close. This forces air through the exhaust port 115. In one implementation, two valves are utilized. However, the number of valves may be increased to increase air flow into the chamber or decreased to save space and reduce costs. Placement of the valves on the distal end of the piston provides for the decreased resistance of air flowing into the hand-actuated pump when the piston is drawn out of the cylinder. This in turn leads to reduced fatigue on the part of the operator.

Each valve 400 includes a valve membrane 405, a bridge support 410, and a valve grill 415. The bridge support 410 is utilized to secure the valve membrane 405 over an opening in the distal end 107a of the piston 107. In some implementations, the valve membrane 405 is circular and has a diameter that is approximately the same size as the diameter of the opening. However, the shape of the valve membrane 405 may be adapted to cover a valve opening with a different shape. The valve membrane 405 may comprise any material suitably flexible, yet impermeable to air flow, such as rubber, to allow unidirectional flow of air.

The valve grill 415 is configured to prevent objects that may obstruct air flow and/or damage the chamber defined by the cylinder 105 and piston 107 from entering through the valve. In some implementations, the valve grill includes tabs or snaps 415a which enable removable attachment of the grill to the distal end 107a of the piston 107.

FIG. 5a and FIG. 5b show an unpacking operation of the hand-actuated pump 100. An inflatable object 500 may be stored in the hand-actuated pump 100. That is, the chamber defined by the cylinder 105 and the piston 107 may be sized to receive the inflatable object 500 in a deflated and folded configuration. To remove the inflatable object 500, the operator may remove the piston 107 from the cylinder 105 as shown in FIG. 5b. The inflatable object 500 may then be removed from the piston 107.

FIG. 6a- FIG. 6c illustrate a pumping operation of the hand-actuated pump 100. In FIG. 6a, the operator may attach the coupler 300 (FIG. 3b) at the exhaust port 115 (FIG. 1) of the hand-actuated pump to a complementary coupler (not shown) on the inflatable object 500. The operator may then lock the hand-actuated pump 100 to the inflatable object 500 by rotating the coupler 300 until the locking members 305 (FIG. 3) engage a set of complementary locking members (not shown) on the coupler of the inflatable object 500.

As shown in FIG. 6b, the operator may then place his hand through the handle 125 and initiate pumping operations to inflate the inflatable object 500. During pumping, should the ring on the piston engage the rumble strips on the cylinder, a rumble may be heard and felt by the operator. This in turn indicates to the operator that the piston is near the end of its operative pumping range.

After the inflatable object 500 is inflated, the operator may remove the hand-actuated pump 100 by performing the reverse of the operations described above and then closing the valve on the inflatable object 500, as shown in FIG. 6c.

While the method and system has been described with reference to certain embodiments, it will be understood by those skilled in the art that various changes may be made and equivalents may be substituted without departing from the scope of the claims. For example, the exhaust cover may be attached to the piston, and the valve cover may be attached to the cylinder. A strap and/or handle may or may not be utilized. The number of valves may be greater or fewer than two.

In addition, many modifications may be made to adapt a particular situation or material to the teachings without departing from the scope of the claims. For example, as shown in FIG. 7, the piston 107 of the hand-actuated pump 100 may include an outward protrusion 705 near the distal end 107a of the piston 107 that is configured to enter a channel 710 positioned on the proximal end 105b of the piston 105. The outward protrusion 705 and channel 710 cooperate to enable selectively locking the piston 107 and the cylinder 105 together.

In operation, a user may initially line up the outward protrusion 705 with a receiving portion 710a of the channel 710. The receiving portion 710a of the channel 710 may extend to the edge of the cylinder 105. The user may then insert the piston 107 into the cylinder 105, thereby inserting the outward protrusion 705 into the receiving portion 710a of the channel 710. The user may then rotate the piston 107 within the cylinder 105, so that the outward protrusion 705 engages a securing portion 710b of the channel 710. Once in the securing portion 710b, the piston 107 is generally prevented from being removed from the cylinder 105 under normal use.

To remove the piston 107 from the cylinder 105, the user reverses the direction of rotation of the piston 107, so that the outward protrusion 705 is positioned within the receiving portion 710a of the channel 710. The user may then pull the piston 107 out of the cylinder 105.

Further modifications may be made. For example, as shown in FIGS. 8a-8c, the coupler 300 may include a channel for receiving a lock member 800. The lock member 800 may cooperate with a lock pin 820 (FIG. 8c) disposed within the cylinder 105 to enable selectively locking the coupler 300 in an extended position, as shown, and/or in a close positioned, as shown in FIG. 3a. The shape of the lock pin 820 of FIG. 8c is exemplary and is shown to illustrate that way in which the lock pin 820 and lock member 800 cooperate to enable selectively locking the coupler 300 in an extended position and/or a closed position. The shape of the lock pin 820 may be different.

The lock member 800 may define one or more retention regions 805a and 805b that are configured to secure the lock pin 800. A first retention region 805a cooperates with the lock pin 800 to secure the coupler 300 in a closed position. A second retention region 805b cooperates with the lock pin 800 to secure the coupler 300 in an extended position. Resilient members 815 positioned within the respective retention regions 805a and 805b are configured to releasably secure the lock pin 820 in the respective retention regions 805a and 805b. This in turn enables releasably securing the coupler 300 in an extended position and/or a closed position.

Therefore, it is intended that the present method and system not be limited to the particular embodiment disclosed, but that the method and system include all embodiments falling within the scope of the appended claims.

We claim:

1. A hand-actuated pump comprising:
a cylinder that includes a proximal end and a distal end that defines an opening;
a piston that includes a proximal end and a distal end said piston configured to be slidably inserted into said distal end of said cylinder;
an exhaust port positioned at said proximal end of said cylinder that includes a coupler configured to be removably attached to an inflatable object and to communicate air to said inflatable object, wherein said coupler is further configured to be selectively locked in at least one of: an extended position, and a closed position.

2. The hand-actuated pump according to claim 1, wherein said piston is configured to be selectively locked to said cylinder when said piston is inserted into said cylinder.

3. The hand-actuated pump according to claim 1, further comprising at least one valve positioned on said distal end of said piston.

4. The hand-actuated pump according to claim 1, further comprising a locking member on said coupler that enables locking said coupler to said inflatable object.

5. The hand-actuated pump according to claim 1, wherein said coupler is rotatable within said exhaust port.

6. The hand-actuated pump according to claim 1, further comprising a cover configured to cover an opening of said coupler.

7. The hand-actuated pump according to claim 1, further comprising a handle defined at said distal end of said piston.

8. The hand-actuated pump according to claim 1, further comprising at least one raised annular ridge defined substantially on an outside surface of said proximal end of said piston, and at least one raised annular ridge defined on an inside surface of said distal end of said cylinder configured to contact said at least one raised annular ridge defined on said outside surface of said proximal end of said piston to produce an audible alert.

9. The hand-actuated pump according to claim 1, further comprising at least one raised annular ridge defined substantially on an outside surface of said proximal end of said piston configured to contact an interior surface of said cylinder to produce a substantially air-tight seal.

10. The hand-actuated pump according to claim 9, further comprising an annular ring positioned at said distal end of said cylinder, said annular ring including an interior surface configured to engage said at least one raised annular ridge defined substantially on said outside surface of said proximal end or said piston to substantially prevent removal of said piston from said cylinder when said hand-actuated pump is pumped.

11. The hand-actuated pump according to claim 1, wherein said valve is configured to allow a unidirectional flow of air into a chamber defined by said piston and said cylinder.

12. The hand-actuated pump according to claim 1, wherein said valve comprises a flexible membrane configured to cover an opening on said piston.

13. The hand-actuated pump according to claim 1, further comprising a grill configured to cover said valve.

14. The hand-actuated pump according to claim 13, further comprising tabs on said grill that enable removable attachment of said grill to said distal end of said piston.

15. The hand-actuated pump according to claim 1, wherein said piston is configured to be removed from said cylinder, and an interior of said piston is configured to receive said inflatable object when said inflatable object is deflated.

16. The hand-actuated pump according to claim 1, wherein said cylinder and piston are comprised of a material selected from a group consisting of: plastic and PVC.

17. The hand-actuated pump according to claim 1, further comprising an inflatable object stored in a chamber defined by said piston and cylinder.

18. A hand-actuated pump comprising:
a cylinder that includes a proximal end and a distal end that defines an opening;
a piston that includes a proximal end and a distal end, said piston configured to be slidably inserted into said distal end of said cylinder, wherein said piston is configured to be selectively locked to said cylinder when said piston is inserted into said cylinder; and
an exhaust port positioned at said proximal end of said cylinder that includes a coupler that is configured to be removably attached to an inflatable object and to communicate air to said inflatable object.

19. The hand-actuated pump according to claim 18, wherein said coupler is further configured to be selectively locked in at least one of: an extended position, and a closed position.

20. The hand-actuated pump according to claim 18, wherein said coupler is rotatable within said exhaust port.
